(19) United States
(12) Patent Application Publication
(10) Pub. No.: US 2004/0089601 A1
(43) Pub. Date: May 13, 2004

(54) Use of polyisocyanate resins in filter layers

(75) Inventors: Gerhard Strohm, Dexheim (DE); Rudiger Leibnitz, Bad Kreuznach (DE); Bernd Henne, Bad Kreuznach (DE)

Correspondence Address: LEYDIG VOIT & MAYER, LTD, 700 THIRTEENTH ST. NW, SUITE 300, WASHINGTON, DC, 20005-3960, US

(73) Assignee: Pall Corporation, East Hills, NY

(21) Appl. No.: 10/383,246

(22) Filed: Mar. 7, 2003

Related U.S. Application Data
(63) Continuation of application No. PCT/DE01/03483, filed on Sep. 6, 2001.

(30) Foreign Application Priority Data
Sep. 7, 2000 (DE) 100 44 218.8

(51) Int. Cl. D21F 11/00; B01D 39/18

(52) U.S. Cl. 210/502.1; 162/158; 162/175; 162/168.3; 210/504; 210/506

(57) ABSTRACT

The invention relates to a wet-strength filter, especially a depth filter with a high swelling capacity, comprising an open-pored filter matrix containing cellulose fibers and having cavities, the cellulose fibers having chemically bonded polyisocyanate on the surface. Preferably, the filter matrix contains finely dispersed microparticles in its cavities. The invention also relates to a method for producing a filter of this type and to the use thereof in the food, beverages and pharmaceutical industries.

The invention relates to filters, in particular, depth filters made of cellulose, which in spite of a wet-strength finish still have excellent swelling properties. The invention further relates to a method for the manufacture and use of such filters.

In technical, in particular large-scale processes, alongside centrifuges, above all, filters are used for separating solid and/or suspended matter from liquids. Filters made up of a felt or fabric consisting of cellulose fibers are often used for this. In such filters, the strength of these fiber fabrics is produced not only by the intertwining of the individual fibers but, above all, also by charge interactions, in particular, hydrogen bonds, which hold the fibers together. When such filters are used in aqueous media, water molecules force their way in between the ionic groups, which results in both a swelling of the cellulose fabric and a reduction in the strength. The filter structure is thereby also altered. Inhomogeneities (e.g. owing to flocculation during the production of the filter layer) in the sheet structure of the dry filter layer increase, from experience, with absorption of water (swelling) and impair the filtration properties of the filter layers because the different mobility of the fibers caused by inhomogeneities increases the faults in the sheet structure. The swelling of the filters in the technical processes is particularly desirable because it makes a considerable contribution towards the sealing of the filter installations, but the decrease in the strength or capability to withstand mechanical stress is highly undesirable as it shortens the service life of a filter, i.e., these must be exchanged more frequently, which results in just as frequent interruptions in the production process. Although both the desired swelling and the undesired reduction in the strength are brought about by the same chemical-physical processes, one endeavors to produce filters with a good swelling capacity and at the same time adequate wet strength. It is also particularly desirable to build up a very homogeneous filter structure in the filter layers in order to improve their filtration properties.

It has, therefore, already been attempted to provide such cellulose filters with a wet-strength finish by means of polyethylene imines and/or polyvinyl amines, as these substances exhibit a pronounced charge interaction with the cellulose fibers. However, this has the disadvantage that for high wet strengths high charge densities are required, which, in turn, lower the filtration yield owing to unwanted adsorption. In addition, the high charge interactions during manufacture of the filters result in increased flocculation in the cellulose fiber pulp, which results in an inhomogeneous filter layer, whereby the filtering efficiency, in particular, the separating efficiency of such filters is impaired. Moreover, here, too, the fiber-fiber bond based only on charge interactions is partly destroyed again by water, and, therefore, the wet strength decreases rapidly during use. Furthermore, filters with such a finish exhibit a wash-out effect, i.e., a washing-out of the wet-strength finish so that its decomposition products are found again in the filtrate. This is highly undesirable, in particular, in the production of food and medicines.

It has, therefore, already been attempted to impart a wet-strength finish to filters containing cellulose fibers by means of polyamine and/or polyamidoamine epichlorohydrin resins. Melamine-formaldehyde resins are also often used to increase the wet strength of such filter materials. However, resins with such a finish liberate chlorine compounds (polyamidoamine epichlorohydrin resins) or, as in the case of melamine-formaldehyde resins, formaldehyde is liberated to an increased extent under the action of heat and moisture, which results not only in malodors but also in contamination of the filtrate. Moreover, the [filters which] with the aforementioned processes [are provided with a wet-strength finish] by means of bridgings caused by chemical cross-linking do not exhibit a satisfactory swelling behavior. In addition, the wet strength finish is chemically decomposed with time, whereby the wet strength decreases in the course of use.

From the paper industry it is known to size paper using polyisocyanate resins under pressure in the paper press, which likewise results in an increased wet strength of the paper. After settling of the fibers on a screen (sheet formation) the resulting web of paper is further drained and compressed, which is carried out in the press section between two rolls exerting a pressure of up to 120 kPa on the web of paper. The fiber-fiber bonds in the paper are thereby increased, which results in a strong increase in the strength. In addition, the paper surface is also smoothed, which is necessary for better inscription. Short cellulose fibers usually with a length of 0.6 to 1.3 mm in the unground state and a fiber diameter of 15 to 20 μm, which are pressed into one another, are used to make paper. These are processed by a fiber-shortening grinding at a low degree of grinding and are bonded to one another under the action of heat in the paper press.

Such processes are described, for example, in DE-A-42 11 480, WO 97/13033, EP-A-0 582 166 and WO 96/38629. The aim of all these processes is to avoid introduction of adsorbable organic halogen (AOX) into the industrial waste water and enrichment of these substances in the paper and in the industrial waste water cycle. This type of sizing results in a wet-strength paper. In the paper industry, a product is already termed as wet-strength product when its wet strength is at least 15% of the dry strength.

Translator's note: [filters which] and [are provided with a wet-strength finish] are missing in the German-language original.

The measures usually employed in the paper industry for increasing the strength, such as pressing, adding gelatinating starch derivatives or sizing the surface, are, however, out of the question for the production of filter layers, as the necessary permeability and porosity of the filter layers is substantially destroyed by these methods.

In the manufacture of filters, however, in contrast to paper, there are no short, closely packed, bonded cellulose fibers lying closely beside another, but instead substantially longer fibers with a higher fiber diameter are joined to form a network with approximately 80% of its volume usually consisting of open-pore void volumes. Only in this way can the permeability of the filter layers required for the filtration be ensured, and, at the same time, the filtration-active filter materials (e.g. kieselguhrs) be bound in a large amount in the filter matrix. In addition, from experience, the strength of such open filter layers is improved by the use of long fibers.

In DE 42 23 604 a process is described for imparting wet strength to molded parts or compression molding compositions consisting of cellulose, paper, straw or derivatives thereof by impregnation with an homogeneous organic polymer solution, in which one or several water-insoluble polymers or polymer derivatives are dissolved, which may comprise isocyanate groups or blocked isocyanate groups. The polymers or their derivatives may also be dissolved in the oil phase of a water-in-oil emulsion.

The wet strength is achieved by finished cellulose molded parts or compression molding compositions being hydrophobized with the polymers by means of impregnation such that entry of water into the composite fiber structure is totally prevented or at least drastically restricted. Such a molded part, which prevents entry of water, is, however, not suitable for filtration of aqueous solutions, as the liquid does not wet the hydrophobized layer and therefore cannot penetrate the filter pores which mostly lie in the micrometer and submicrometer range. Moreover, such molded parts do not display any swelling behavior and do not exhibit a complete strengthening of the entire body.

The object of the invention is to make available filters with a wet-strength finish, whose service life is considerably prolonged, and which exhibit a swelling capacity, which, in comparison with that of the untreated product, is the same or only slightly lower.

A further object of the invention is to make available a filter which in spite of an increased swelling capacity also has a better filtering efficiency than filters which are produced in accordance with the state of the art with other wet-strength resins (e.g. polyamidoamine epichlorohydrin resins, melamine-formaldehyde resins). Finally, filters are to be made available, which, in comparison with the previously known filters with a wet-strength finish, have a significantly longer service life. Furthermore, such filters are not to bleed, i.e., they are not to release their wet-strength finish into the filtered product. Finally, the filter is also to remain stable and retain the above-mentioned properties when used under increased temperature conditions.

In accordance with the invention, this object is now achieved by bringing about the improved swelling capability by treating the cellulose fibers of the filter matrix with a polyisocyanate. This treatment is carried out, in particular, prior to formation of the filtration layer and expediently in suspension or a suspended mash.

Filters, in particular depth filters, have a substantially higher weight per unit area of usually 200-3,500 g/m² as compared with papers. Moreover, they often contain up to 70 wt % inorganic filter-active substances.

The filters according to the invention usually contain 0.01-10 wt %, preferably 0.1-5 wt %, and, in particular, 0.5-3 wt % polyisocyanate, with even amounts of only <2 wt % polymer or 0.05-2 wt % in relation to the layer mass mostly being adequate. In many cases, amounts of 0.1-1.2 wt % have proven expedient. Here the term layer mass includes all materials contained therein, such as cellulose, kieselguhrs, perlites, etc. In accordance with the invention, it was found that with these amounts the fibers are preferably provided with the polyisocyanate only at contact points at which they touch one another and at which they are bonded to one another, with the swelling capability of the fiber net being maintained.

In principle, however, it is possible in accordance with the invention to also use larger amounts of polyisocyanate if the fiber suspension is sufficiently diluted. In this case, not only the surfaces or parts of the surface or points of the fibers are provided with the isocyanate, but also small suspended polymer particles are produced, which can be embedded in a uniform distribution as additional filter components or auxiliary filtering agents in the void volumes of the filter matrix.

In accordance with the invention, hydrophilic polyisocyanates, as described, for example, in WO 96/38629, WO 97/13033 and EP-A-564 912, are preferably used for this purpose.

In accordance with the invention, the polyisocyanates are normally used in the form of emulsions (oil in water), as generally known to one skilled in the art and producible from commercially available polyisocyanates. Normally, water-dispersible polyisocyanates or mixtures thereof are used in diluted form or are added to the mash, usually in a concentration of up to 20 wt %, preferably up to 10 wt % in water, expediently as fine-particle dispersions with particle sizes ≦500 nm. In the mash in which the fibers are treated, the concentration of the polyisocyanate resin is freely selectable as long as the desired bonding effect is achieved. With higher concentrations, this can also be achieved by dilution of the fiber suspension and simultaneous formation of solid resin particles, which can be incorporated as auxiliary filtering agents in the matrix. In the suspension, amounts or concentrations of 0.0001 wt % to 0.5 wt % or 0.00015 wt % to 0.45 wt % resin have normally proven expedient. However, 0.0015 wt % to 0.23 wt % and, in particular, 0.0075 wt % to 0.14 wt % resin is preferably used in the mash. The concentration of the raw materials, i.e., fibers and any other solid auxiliary agents present is preferably 1.5 wt % to 4.5 wt % solids in the suspension mash.

The cellulose filters according to the invention are largely produced (30-100% of the cellulose proportion, preferably >50%) from long fibers with a length >2 mm, preferably 2-4 mm, in particular, 2.5-4 mm and a fiber diameter of >25 μm, preferably >30 μm (in the unground state). They exhibit a long-lasting stability and are preferably ground fibrillatingly in the manufacturing process, with high degrees of grinding of up to 80° SR partly being used.

The filters according to the invention preferably contain in their filter matrix additional filter components such as polysaccharides, cellulose derivatives such as cellulose acetate, agarose and derivatives thereof, dextranes and chitosans, and derivatives thereof, and, in particular, inorganic particles such as natural silicate compounds, e.g., kieselguhr, layered silicates, perlites, xerogels, feldspars, zeolites, montmorillonites, molecular sieves and ion exchangers, active carbon, titanium dioxide, zinc sulfide, calcium carbonate, talcum powder and synthetic organic polymeric particles, which, in particular, may also consist of the above-mentioned reactive wet-strength resins, polyvinyl pyrrolidone (PVP or PVPP) and starch and starch derivatives such as oxidized and alkylated starches and synthetic fiber materials such as, for example, polyethylene, polypropylene. The filters may contain up to 70 wt % of these filter components in relation to the total content of the filter.

Surprisingly, it was found that the filter layers according to the invention have a better filtration efficiency than other filter layers finished with commercial wet-strength resins. The filtering efficiency is characterized to a considerable degree by the permeability and the clarifying effect of the filter layer and can be quantitatively described under defined filtering conditions.

An essential precondition for good filtering efficiency is a distribution of all filter components which is as homogeneous as possible in the filter layer. Inhomogeneities such as flocculations in the wet section of the filter layer manufacture are, however, not completely avoidable due to the use of cationic wet-strength resins. They impair the homogeneous sheet structure, but are absolutely essential for the necessary wet strength. The flakes are created by destabilization of negatively charged fibers and fine materials in the filter material pulp as a result of breakdown of their charge by means of cationic wet-strength resins and subsequent flocculation.

A further additional explanation for the improved filtering efficiency is seen in the fact that the reactive polyisocyanate present in water in the form of small emulsion drops can form by self-crosslinking (possible side reaction in the aqueous emulsion) very small cured polymer particles which are retained by the filtration-active filter components in the filter layer, so that the accessible filtration-active surface available in total is thereby increased and the filtering effect of the filter layers according to the invention is positively influenced. In spite of the good swelling properties, the filter layers according to the invention are characterized by a delayed wetting behavior with water. This hydrophobizing has already been described for anionically modified polyisocyanates in connection with cationic retention agents in paper finishing (EP 0 828 890 B1). It has now been found that this effect also occurs with use of cationically modified polyisocyanates in filter layer manufacture, particularly with an increasing amount of polyisocyanate and longer dwell time (5-180 minutes, preferably 30-90 minutes) of the resin in a tempered filter material pulp (20-60° C., preferably 30-45° C.). It is assumed that the longer dwell time of the polyisocyanate resin and the temperature in the filter material pulp influence the pre-crosslinking and retention of the polyisocyanate in such a way that the filter layers according to the invention exhibit a reduced wetting behavior for water.

In principle, it has been shown that an increased charge of polyisocyanate promotes an increase in the hydrophobizing of the filter layers as does a longer dwell time and reaction time of the polyisocyanates in the filter material pulp. An increase in the temperature also promotes a hydrophobizing of the filter layer. This effect can be counteracted by a reduction of the fiber concentration in the suspension.

Although the storage of filter layers has not caused any problems so far, it was found that this hydrophobizing results in an increased storage life, because the water absorption of the filter layers via the air humidity is thereby reduced.

Moreover, it was found that a lower water absorption of the filters results in a substantially lower susceptibility of the filter material to microbic contamination, and an undesired undulation of filter layers is reduced. In addition, the chemical degradation process is also slowed down by a lower water absorption.

The wetting behavior can be characterized, as in determining the degree of sizing in the paper industry, by the resistance of the filter surface to the penetration of aqueous solutions, as indicated in Example 5.

The invention also relates to a method for producing such filter layers, which is characterized in that the cellulose fibers are treated with polyisocyanates before formation of the filter layer. Herein the cellulose fibers are suspended in a suspension medium and treated in the suspended state with one or several polyisocyanates. Preferred suspension media are aqueous media, but suspension media containing organic components such as, for example, a water-in-oil emulsion or an oil-in-water emulsion, may also be used. In the treatment of the cellulose fibers the surface of the fibers or parts or dot-shaped areas are preferably treated with the polyisocyanate. The polyisocyanate can be both directly covalently crosslinked with functional groups located at the surface of the fibers or also adsorptively bonded to the surface in a non-covalent manner. Such bondings are expediently achieved by thermal treatment. The thus treated suspended cellulose fibers are subsequently precipitated so as to form a layer, in particular, an open-pore layer, which is usually done by removal of the suspension agent, with a filter matrix being produced, in which the polyisocyanate is usually homogeneously distributed in the matrix. A common way of forming such filtration layers is to withdraw the suspension medium by suction on a carrier screen. The thus obtained layer is subsequently dried at temperatures of from 80° C. upwards, expediently at 80-200° C., preferably at 100-180° C., and, in particular, at 110-150° C. In accordance with the invention, it has been shown that the desired wet strength is already obtained after the drying, with the swelling effect being maintained, so that no further treatment is necessary.

With the method according to the invention depth filter layers can be produced with a weight per unit area of 200-300 g/m², preferably 500-2,000 g/m², and a wet strength of 20 N/5 cm-500 N/5 cm, preferably 50-300 N/5 cm.

The wet strength is determined as described in German Industrial Standard 53112 Part 2, where in a tensile test on an aqueous sample, the force required to break or tear this sample is determined. This force is referred to as wet breaking force. Samples with a free clamping length of 100±2 mm and a width of 50 mm are clamped in a tensile testing machine which indicates the measured force at the moment of breakage of the sample. To determine the initial wet strength, the specimens are placed for 5 minutes in a vessel in which they are totally immersed. The permanent wet strength is then determined in the same manner, but instead of the soaking in water, the layers are subjected to different loads and then tested in the tensile testing machine for wet strength. The filters according to the invention or the filters produced in accordance with the invention are preferably to be used for producing food and beverages, and, in particular, beer and wine, and also medicines.

The invention will now be explained in further detail by the following examples.

Cellulose fiber substances were treated with commercial wet-strength agents, namely melamine-formaldehyde resin [Madurit M W 167 (10% solution, Vianoova Resins)], polyamidoamine-epichlorohydrin resin [Luresin K N U (BASF)], polyvinyl amine [Baso-coll 8086 (BASF)], polyethylene imine [Polyamin P (BASF)], polyisocyanate [ISOVIN VP SP 42004 (Bayer)], CMC [Tylose C30 (Clariant)], silica sol [Klar-Sol-Super (Erbslöh)], polyacrylate [Acronal 27 D (BASF)].

To manufacture the filters, the wet-strength resins and/or further additives in the form of aqueous suspensions or emulsions, preferably in the form of a 1-10 wt % dilution, are stirred into a cellulose pulp. The filter layer formation takes place subsequently on a laboratory sheet former, with which the industrial filter layer manufacture can be simulated under idealized conditions. As on the Fourdrinier machine, the layer formation is carried out by a vertical draining of the fiber suspension through a screen, with the aid of negative pressure. For filter layer formation, the loading chamber of the sheet former is filled with water from below and 2,000 ml of a 2% cellulose pulp are fed in from above. After reaching the 4-liter mark, the water supply is cut off and the pulp suspension is mixed thoroughly for 5 s with compressed air. The suspension is subsequently allowed to settle for 5 s before the draining procedure is started by applying a negative pressure. After the liquid level has dropped through the fiber fleece, air is still sucked through the sheet for 10 s. The resulting layer is finally dried at 130-150° C. The wet strength of the depth filters thus obtained is determined after placement in water for 5 minutes.

The values obtained are stated in the following Table under [1].

The filters were then treated in accordance with the methods described hereinbelow as test A to test C in order to determine the permanent wet strength.

### Test A

Here the filter layers in a layer filter were alternately subjected to steam for 30 minutes and subsequently rinsed with a 10% ethanol-water mixture at pH 3 for 30 minutes, 10 times each, at 1 bar pressure (10⁵ Pa) each time. They were then rinsed with a 2.5% caustic soda solution (10 minutes, 500 l/m²h) and the wet strength was subsequently determined on specimens of 5 cm width and 15 cm length.

### Test B

The respective filters were autoclaved eight times at 121° C. (0.1 MPa (1 bar) excess pressure).

### Test C

Here the filters were each rinsed one hundred times with hot water at 90° C. (500 l/m²h, 20 minutes) and one hundred times with cold water at 20° C.

### EXAMPLE 1

### Direct Comparison with Other Wet-Strength Resins, Without the Addition of Auxiliary Retention Agents

### Test A

Kieselguhr-free cellulose filter substance (pine material treated according to the sulfate process, pulp density: 3%, degree of grinding: 25° SR); weight per unit area: 640 g/m²; initial wet strength [1] and permanent wet strength [2] in N/5 cm.

| | Initial | Permanent wet | |
|---|---|---|---|
| Filter | wet strength | strength | Decrease |
| plus 4.0% Melamin- | [1]:180 | [2]:3-5 | approx. 98% |
| Madurit MV 167 | | | |
| (Vianova Resins) | | | |
| plus 1.2% | [1]:130 | [2]:75 | 42% |
| polyisocyanate | | | |
| (ISOVIN VP SP | | | |
| 42004) (Bayer) | | | |
| plus 2.0% | [1]:160 | [2]:45 | 72% |
| polyamidoamine- | | | |
| epichlorohydrin resin, | | | |
| Luresin KNU (BASF) | | | |
| plus 2.0% polyvinyl | [1]:125 | [2]:25 | 80% |
| amine, Basocoll 8086 | | | |
| (BASF) | | | |
| plus 2.0% | [1]:105 | [2]:20 | 81% |
| polyethylene imine, | | | |
| Polymin P (BASF) | | | |

### Test B

55% pine material treated according to the sulfate process/linters, pulp density: 3%, degree of grinding: 30° SR; 45% kieselguhrs; initial wet strength [1] and permanent wet strength [2] in N/5 cm; weight per unit area: 1280 g/m²

| | Initial | Permanent wet | |
|---|---|---|---|
| Filter | wet strength | strength | Decrease |
| plus 0.7% | [1]:95 | [2]:70 | 26% |
| polyisocyanate | | | |
| (ISOVIN VP SP 42004) | | | |
| (Bayer) | | | |
| plus 0.7% | [1]:83 | [2]:29 | 65% |
| polyamidoamine- | | | |
| epichlorohydrin resin, | | | |
| Luresin KNU (BASF) | | | |

### Test C

55% pine material treated according to the sulfate process/linters, pulp density: 3%, degree of grinding: 30° SR; 45% kieselguhrs; initial wet strength [1] and permanent wet strength [2] in N/5 cm; weight per unit area: 1280 g/m²

| | Initial | Permanent wet | |
|---|---|---|---|
| Filter | wet strength | strength | Decrease |
| plus 0.7% | [1]:95 | [2]:92 | 3% |
| polyisocyanate | | | |
| (ISOVIN VP SP 42004) | | | |
| (Bayer) | | | |
| plus 0.7% | [1]:83 | [2]:36 | 57% |
| polyamidoamine- | | | |
| epichlorohydrin resin, | | | |
| Luresin KNU (BASF) | | | |

### EXAMPLE 2

### Increase in Effect Due to Addition of Retention Agents

### Test A

Filter layer composition:

55% pine material treated according to the sulfate process/linters, pulp density: 3%, degree of grinding: 30° SR; 45% kieselguhrs; weight per unit area: 1280 g/m²; addition of retention agent carboxymethyl cellulose (CMC)

| | Initial | Permanent wet | |
|---|---|---|---|
| Filter | wet strength | strength | Decrease |
| plus 1.2% | [1]:140 | [2]:40 | 69% |
| polyamidoamine- | | | |
| epichlorohydrin resin, | | | |
| Luresin KNU (BASF) | | | |
| plus 0.25% CMC, | | | |
| Tylose C30 (Clariant) | | | |
| plus 1.2% | [1]:180 | [2]:125 | 31% |
| polyisocyanate | | | |
| (ISOVIN VP SP 42004) | | | |
| (Bayer) | | | |
| plus 0.25% CMC, | | | |
| Tylose C30 (Clariant) | | | |

### EXAMPLE 3

### Combination with Other Wet-Strength Resins

### Test A

Filter layer composition:

55% pine material treated according to the sulfate process/linters, pulp density: 3%, degree of grinding: 30° SR; 45% kieselguhrs; weight per unit area: 1280 g/m²

| | Initial | Permanent wet | |
|---|---|---|---|
| Filter | wet strength | strength | Decrease |
| plus 0.25% | [1]:120 | [2]:70 | 42% |
| polyamidoamine- | | | |
| epichlorohydrin resin, | | | |
| Luresin KNU (BASF) | | | |
| plus 0.75% | | | |
| polyisocyanate | | | |
| (ISOVIN VP SP 42004) | | | |
| (Bayer) | | | |
| plus 0.25% | [1]:105 | [2]:65 | 38% |
| polyvinyl amine, | | | |
| Basocoll 8086 (BASF) | | | |
| plus 0.75% | | | |
| polyisocyanate | | | |
| (ISOVIN VP SP 42004) | | | |
| (Bayer) | | | |

### EXAMPLE 4

### Filtration Efficiency on the Basis of a Model Substance Suspension

a)

Filter layer composition:

55% pine material treated according to the sulfate process/linters, pulp density: 3%, degree of grinding: 30° SR; 45% kieselguhrs; weight per unit area: 1280 g/m²

Filtration conditions: testing pressure: 1000 mbar; testing time: 1800 s

### Determining the Retention Capacity of the Filter Layer with Respect to Turbid Particles of a Model Substance Suspension

The filter layer is subjected under defined conditions (testing pressure: 1000 mbar, testing time: 30 minutes) to a model substance suspension (e.g. 0.7% raw cane sugar solution, Ovomaltine/coffee substitute suspension=model suspension 1), and the filtration behavior (throughput and clarifying effect) determined. From the determined volumetric flow rate [l/h] and the turbidity [TE/F] of the filtrate, perviousness (permeability) and clarifying effect of the filter layer can be described quantitatively. Only both layer parameters together characterize the essential efficiency features of a filter layer.

With the formula for the value A (see below) both filtration parameters can be quantitatively [%] described by the value A in a direct layer comparison. The value A expresses the improved efficiency of the new filter layers made with a polyisocyanate in comparison with a layer made with a polyamidoamine-epichlorohydrin resin. In Example 4a, according to formula A there is a 45% increase in efficiency with the filter layer made with polyisocyanate. This results in this example from a better clarifying efficiency of the new polyisocyanate filter layer with a simultaneous increase in permeability with respect to the comparative layer.

| | Mean | | |
|---|---|---|---|
| | volumetric flow | Turbidity | According to |
| Resin | rate [l/h] | [TE/F] | formula A [%] |
| 0.75% polyisocyanate | 22.3 | 0.32 | 45 |
| (ISOVIN VP SP 42004) | | | |
| (Bayer) | | | |
| 0.75% polyamidoamine- | 20.0 | 0.43 | 0 |
| epichlorohydrin resin, | | | |
| Luresin KNU (BASF) | | | |

b)

The filters according to the invention also exhibited a superior filtering efficiency with a model substance suspension that was modified with respect to Example 4a). The model substance suspension Eura/Ovomaltine was manufactured as follows: 2.0 g Ovomaltine, WASA GmbH, Celle, and 7.0 g coffee substitute extract, Guenzburger Nahrungsmittelwerke company, Guenzburg, are stirred into 1 l of water and then topped up under strong stirring to 100 l (model substance suspension 2) and used in aqueous suspension in accordance with “Testing Methods Depth Filter Media Filter Layers” of the work group Technik/Analytik of the European Specialized Association Tiefenfiltration e.V. (EFT) for filtration tests.

Filter layer composition:

55% pine material treated according to the sulfate process, pulp density: 3%, degree of grinding: 43° SR; 45% kieselguhrs; weight per unit area: 1280 g/m²

Filtration conditions: testing pressure: 1000 mbar; testing time: 1800 s

Model substance suspension 2

| | Mean | | |
|---|---|---|---|
| | volumetric flow | Turbidity | According to |
| Resin | rate [l/h] | [TE/F] | formula A [%] |
| 1% polyisocyanate | 22.3 | 0.93 | 16 |
| (ISOVIN VP SP 42004) | | | |
| (Bayer) | | | |
| 1% polyisocyanate | 20.5 | 0.84 | 18 |
| (ISOVIN VP SP 42004) | | | |
| (Bayer) | | | |
| plus 0.2% polyacrylate, | | | |
| Acronal 27D (BASF) | | | |
| 1% polyisocyanate | 20.4 | 0.86 | 15 |
| (ISOVIN VP SP 42004) | | | |
| (Bayer) | | | |
| plus 0.2% | | | |
| carboxymethyl cellulose | | | |
| (CMC), Tylose C30 | | | |
| (Clariant) | | | |
| 1% polyisocyanate | 21.9 | 0.81 | 31 |
| (ISOVIN VP SP 42004) | | | |
| (Bayer) | | | |
| plus 0.2% silica sol, | | | |
| Klar-Sol-Super (Erbsloh) | | | |
| 1% polyamidoamine- | 19.8 | 0.96 | 0 |
| epichlorohydrin resin, | | | |
| Luresin KNU (BASF) | | | |

### Explanation

In the following formula both filtration parameters (volumetric flow rate and turbidity) are quantitatively described by the value A in a direct layer comparison (PIC-EPI-layer). The differences from the polyamidoamine-epichlorohydrin layers are obvious.

$$A = [ \frac{( vol {.}_{sample} / vol {.}_{epi} )}{( turb {.}_{sample} / turb {.}_{epi} )} - 1 ] \times 100$$

### Evaluation

The percentage differences (A values) document the improved efficiency of the new filter layers made with a polyisocyanate as compared with a layer made with a polyamidoamine-epichlorohydrin resin.

### EXAMPLE 5

### Sizing Effect

### Test Conditions

Filter layer composition: To a dried filter layer consisting of kieselguhr-free cellulose filter substance (pine material treated according to the sulfate process, pulp density: 3%, degree of grinding: 25° SR, weight per unit area: 640 g/m², laboratory sheet), with approximately 3% residual moisture, 6 drops of water are carefully applied with a pipette, and the required time for penetration of the water drop into the filter layer (mean value from 6 measurements) is measured (drop test).

Similarly to determination of the degree of sizing in the paper industry, the test characterizes the resistance of the filter surface to penetration of aqueous solutions. The filter layers can thus be differentiated with respect to wettability of the filter layer.

A drop of water is applied to the dried filter layers (moisture content: 3%) and the penetration time measured (drop test).

| | | Temperature | Dwell time in |
|---|---|---|---|
| | | [° C.] of filter | filter material |
| Resin in % | Drop test [s] | material pulp | pulp [min] |
| 0.5 polyisocyanate | approx. 30 | 35 | 10 |
| (ISOVIN VP SP 42004) | | | |
| Bayer | | | |
| 0.75 polyisocyanate | approx. 180 | 35 | 10 |
| (ISOVIN VP SP 42004) | | | |
| Bayer | | | |
| 1.0 polyisocyanate | approx. 240 | 35 | 10 |
| (ISOVIN VP SP 42004) | | | |
| Bayer | | | |
| 5 polyisocyanate | >600 | 35 | 10 |
| (ISOVIN VP SP 42004) | | | |
| Bayer | | | |
| 0.75 polyamidoamine- | <5 | 35 | 10 |
| epichlorohydrin resin, | | | |
| Luresin KNU (BASF) | | | |
| 0.75 polyisocyanate | approx. 100 | 22 | 10 |
| (ISOVIN VP SP 42004) | | | |
| Bayer | | | |
| 0.75 polyisocyanate | approx. 130 | 22 | 120 |
| (ISOVIN VP SP 42004) | | | |
| Bayer | | | |

### EXAMPLE 6

In order to test the swelling capacity of the fibers, pure cellulose layers (as in Test A) were examined. The water retention capability (WRC) was determined as follows: 20 g of the dried layer are beaten for 20 minutes in water, subsequently a sample is centrifuged off at 3,000 rpm. The wet cake centrifuged off is weighed (mₘₒᵢₛₜ), then dried in the drying cabinet, and the dry weight determined anew (m_{dry}).

WRC(%)=(mₘₒᵢₛₜ−m_{dry})×100/m_{dry}

While the conventional resins lead to a decrease in the WRC value (swelling), the swelling capability of the cellulose sheets which were manufactured in accordance with the invention with a polyisocyanate remains almost constant. In the past, the amount of resin always had a particularly negative effect on the swelling properties of the filter layers. Taking into account the measuring accuracy, it is found that polyisocyanate resin does not reduce the swelling properties of the celluloses as strongly as other resins (see below).

| | | Amount | | Reduction |
|---|---|---|---|---|
| No. | Resin | of resin (%) | WRC (%) | WRC (%)* |
| 1 | without resins | — | 105 | — |
| 2 | polyamidoamine- | 1.2 | 91 | 14 |
| | epichlorohydrin resin, | | | |
| | Luresin KNU (BASF) | | | |
| 3 | polyvinyl amine | 1 | 93 | 12 |
| | Basocoll | | | |
| | 8086 (BASF) | | | |
| 4 | Melamine/formaldehyde | 1 | 97 | 8 |
| | resin, Madurit MV 167 | | | |
| | (Vianova Resins) | | | |
| 5 | polyisocyanate | 1.2 | 103 | 2 |
| | ISOVIN VP | | | |
| | SP 42004 (Bayer) | | | |

*mean value from 3 tests

1. Filter with a wet-strength finish, in particular, depth filter, with high swelling capacity, comprising a filter matrix containing cellulose fibers and having open-pore void volumes, characterized in that the cellulose fibers have polyisocyanate chemically bonded to their surface.

2. Hydrophilic filter as defined in claim 1, characterized in that the cellulose fibers are bonded to each other by means of polyisocyanate.

3. Filter as defined in any one of the preceding claims, characterized in that the filter matrix contains microparticles finely dispersed in its void volumes.

4. Filter as defined in claim 3, characterized in that the microparticles contain polyacrylates, carboxymethyl cellulose, kieselguhrs, silica gels, polyisocyanates, polysaccharides, acryl acrylates, starch, carboxymethyl starch, oxidized starch and/or ion exchangers.

5. Filter as defined in claim 4, characterized in that it contains at least one additional filter component in an amount of 5-70%, preferably 20-60%, in the filter layer.

6. Filters as defined in any one of the preceding claims, characterized in that they contain 0.01-10 wt % polyisocyanates with respect to the total content of the filter layer.

7. Filter as defined in any one of the preceding claims, characterized in that the polyisocyanate is a hydrophilic polyisocyanate.

8. Filter as defined in any one of the preceding claims, characterized in that the polyisocyanate is a cationic polyisocyanate.

9. Method for producing filters with a permanent wet-strength finish containing cellulose fibers with improved filtration and swelling properties, in particular, as defined in any one of claims 1-8, characterized in that the cellulose fibers and/or the filter are treated with polyisocyanates prior to layer formation.

10. Method as defined in claim 9, characterized in that the cellulose fibers are treated in suspension with polyisocyanates.

11. Method as defined in either one of claims 9 or 10, comprising preparation of an aqueous suspension of cellulose fibers, treatment of the surface of the suspended cellulose fibers with one or more polyisocyanates in a concentration of from 0.0001 wt % to 0.5 wt % polyisocyanate and a solids concentration of from 1 wt % to 5 wt %, formation of a layer and drying of the layer thus obtained.

12. Use of filters as defined in any one of claims 1-8 to produce food, beverages, chemical and pharmaceutical preparations.
